(19) United States
(12) Patent Application Publication
(10) Pub. No.: US 2017/0140671 A1
(43) Pub. Date: May 18, 2017

(54) SURGERY SIMULATION SYSTEM AND METHOD

(71) Applicant: Dracaena Life Technologies Co., Limited, Hong Kong (HK)

(72) Inventors: Yim Pan Wystan Chui, Hong Kong (HK); Wai Man Raymond Pang, Hong Kong (HK); Pheng Ann Heng, Hong Kong (HK)

(21) Appl. No.: 15/417,238

(22) Filed: Jan. 27, 2017

Related U.S. Application Data
(63) Continuation of application No. PCT/CN2015/084026, filed on Jul. 15, 2015.

(30) Foreign Application Priority Data
Aug. 1, 2014 (CN) 201410377905.0

(51) Int. Cl. G09B 23/30; G09B 9/00

(52) U.S. Cl. CPC G09B 23/30; G09B 9/00

(57) ABSTRACT

A surgery simulation system and method is disclosed. The surgery simulation system includes a simulation platform provided with a physical model thereon for simulating a human organ for incising and/or piercing; a force feedback device provided with an actuator and a surgical instrument connection component thereon, the surgical instrument connection component being detachably connected to a surgical instrument; a three-dimensional tracker for tracking the surgical instrument; a display device for displaying a virtual organ and/or a medical image; a control module having an electrical signal connection with the force feedback device, the three-dimensional tracker and the display device, controlling the force feedback device according to the signal of the three-dimensional tracker, and displaying a corresponding image on the display device. The surgery simulation system and method vividly simulates the scene of a real operation so as to assist medical staff to quickly master surgical skills.

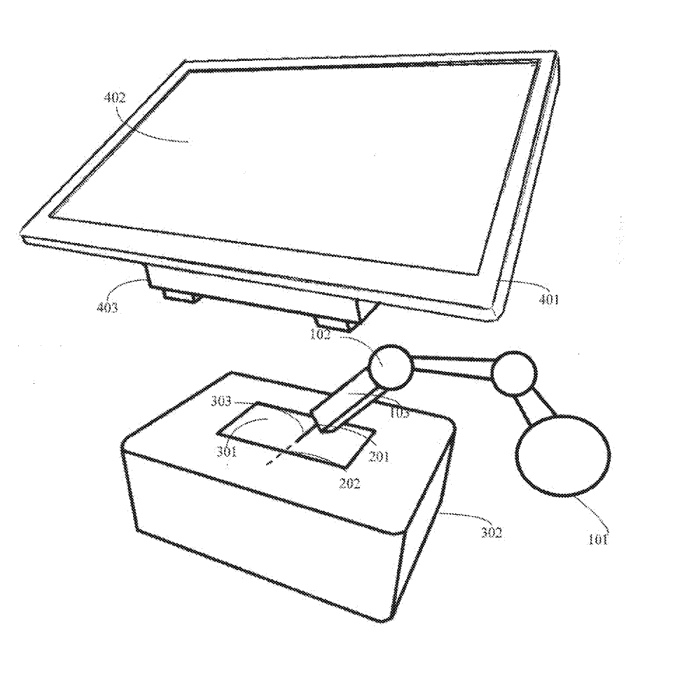

### CROSS REFERENCE TO RELATED APPLICATIONS

The present application is a Continuation application of PCT application No. PCT/CN2015/084026 filed on Jul. 15, 2015, which claims the benefit of Chinese patent application No. 201410377905.0 filed on Aug. 1, 2014. All the above are hereby incorporated by reference.

### FIELD OF THE TECHNOLOGY

The present application relates to the field of surgery simulation, and more particularly to a surgery simulation system and method, and particularly a simulation system and method for surgery on a human organ with haptic feedback.

### BACKGROUND

Piercing and incision are very common operations in a surgery. They are the basic common skills that should be mastered by almost every doctor. For surgery such as intervention of tumor, fetal diagnosis, radio frequency tumor ablation, local anesthesia, percutaneous catheterization and endoscopic surgery, exquisite technique is required because difficulty of operation is relatively high. Exquisite technique requires extensive training to achieve. For example, a surgeon may need to practice on dozens of patients in order to master the skills. However, since many of the surgeries are highly risky, therefore it is obviously not feasible to master the skills through practice on patients. There is a long history of using human body-simulated physical models in medical training. The human body-simulated physical model is an object that simulates a real organ. It can provide a situation similar to an actual operation. However, due to limitations of the model, the actual structure of the interior of a human body cannot be truly reconstructed, and misleading in basic operation may be caused.

### SUMMARY

An object of the present application is to provide a surgery simulation system and method for surgery simulation training so as to assist doctors to quickly master the skills such as incision and piercing.

According to one aspect, there is provided a surgery simulation system including:
a simulation platform, the simulation platform being provided thereon with a physical model that simulates a human organ to be incised and/or pierced, and allows a surgical instrument to physically incise and/or pierce therethrough;
one or more sets of force feedback devices, each set of the force feedback devices being connected with an actuator and a surgical instrument connection component, position of the actuator being detected and recorded by an internal or external three-dimensional sensor, the surgical instrument being detachably connected with the surgical instrument connection component;
a three-dimensional tracker, being a depth camera, an optical tracker, or an electromagnetic tracker, that tracks location and orientation of an exposed portion of the surgical instrument, detects and records a position of an incision point and/or piercing point on the physical model by the surgical instrument; and
a control module, the control module having electrical signal connection with the force feedback device, the three-dimensional tracker and a display device, controlling the force feedback device according to signals of the actuator and the three-dimensional tracker, and displaying a corresponding image on the display device.

In one embodiment of the surgery simulation system, before the surgical instrument is inserted into the physical model, feedback force is provided by the force feedback device; when the surgical instrument is pierced into the physical model, extended calculation of the position of the incision point and/or piercing point is performed via the surgical instrument connection component and the actuator, and feedback force is provided together by the surgical instrument connection component, the force feedback devices which are connected with the surgical instrument connection component, and the physical model; and when the surgical instrument is operating in the physical model, feedback force is provided together by the surgical instrument connection component, the force feedback devices which are connected with the surgical instrument connection component, and friction at an interior of the physical model.

In one embodiment of the surgery simulation system, the surgical instrument is a piercing and/or incision instrument, the surgical instrument comprising a rotatable handle and a needle, blade, stoma dilator, stoma sheath, penetration-type probe or lens provided on the handle.

In one embodiment of the surgery simulation system, the display device displays the surgical instrument, a virtual organ and/or a medical image.

In one embodiment of the surgery simulation system, the physical model is formed with a membrane having a soft surface for repeat incision and/or piercing by the surgical instrument, an interior of the physical model is filled with a soft material that generates friction when the surgical instrument is inserted therein, and restricts the surgical instrument's path after insertion.

According to another aspect, there is provided a method for simulating a surgery including:
providing a simulation platform, the simulation platform being provided thereon with a physical model that simulates a human organ to be incised and/or pierced;
using a force feedback device to simulate feedback force acting on an operator during surgery, the force feedback device being connected with an actuator and one or more surgical instrument connection components, position of the actuator being detected and recorded by an internal or external three-dimensional sensor, a surgical instrument being detachably connected with the surgical instrument connection components;
using a three-dimensional tracker to track location and orientation of an exposed portion of the surgical instrument, detect and record location of an incision point and/or piercing point on the physical model formed by the surgical instrument, the three-dimensional tracker being a depth camera, an optical tracker, or an electromagnetic tracker; and
using a control module to control the force feedback device according to signals of the actuator and the three-dimensional tracker, and displaying a corresponding image through a display device.

In one embodiment of the method for simulating a surgery, before the surgical instrument is inserted into the physical model, feedback force that simulates gravity force of the surgery instrument is provided by the force feedback device; when the surgical instrument is pierced into the physical model, feedback force that simulate piercing force of the surgery instrument is provided together by the force feedback device and the physical model; and when the surgical instrument is operating in the physical model, feedback force is provided together by the force feedback device, and friction at an interior of the physical model.

In one embodiment of the method for simulating a surgery, the surgical instrument is a piercing and/or incision instrument, the surgical instrument comprising a rotatable handle and a needle, blade, stoma dilator, stoma sheath, penetration-type probe or lens provided on the handle, and after the surgery instrument is replaced, the display device accordingly displays the surgery instrument after replacement.

In one embodiment of the method for simulating a surgery, the display device displays the surgical instrument, a virtual organ and/or a medical image.

In one embodiment of the method for simulating a surgery, the physical model is formed with a membrane having a soft surface for repeat incision and/or piercing by the surgical instrument, an interior of the physical model is filled with a soft material that generates friction when the surgical instrument is inserted therein, and restricts the surgical instrument's path after insertion.

The surgery simulation system and method of the present application has the following beneficial effects. The surgery simulation system and method of the present application employ a method of combining a force feedback device and a physical model to simulate a surgery. This can more vividly simulate the scene of a real surgery so as to assist medical staff to quickly master skills.

### BRIEF DESCRIPTION OF THE DRAWINGS

The surgery simulation system and method of the present application will now be further described with reference to the accompanying drawings.

The FIGURE is a schematic view of a surgical simulation system of the present application, showing force feedback device 101, actuator 102, surgical instrument connection component 103, surgical instrument 201, portion of surgical instrument inserted into a physical model 202, physical model 301, simulation platform 302, piercing point 303, display device 401, displayed image 402, and three-dimensional tracker 403.

### DETAILED DESCRIPTION

For a better understanding of the technical features, objects and effects of the surgery simulation system and method of the present application, specific embodiments will now be described in detail with reference to the accompanying drawings.

The FIGURE shows a schematic view of a surgical simulation system of the present application which can be used for simulation of basic surgical operations such as piercing and/or incision. As shown in the figure, the surgical simulation system may include a simulation platform 302, a force feedback device 101, a three-dimensional tracker 403, a display device 401, and a control module.

The simulation platform 302 can serve as a platform for performing simulated piercing and/or incision operations. The simulation platform 302 may be provided thereon with a physical model 301. The physical model 301 may be used to simulate a human organ for piercing and/or incision operation. The physical model 301 can be replaced as needed in order to provide a different surgery simulation.

The force feedback devices 101 can be used to simulate feedback force acting on an operator during surgery. The force feedback device 101 may come with one or more sets for simulating one-handed operation, such as a left-handed or right-handed one-handed operation, or simulating surgery that requires operation by both hands, such as operation that requires both hands to hold the surgical instruments. Each set of the force feedback device 101 may be connected with an actuator 102 and one or more surgical instrument connection components 103. The actuator 102 may include a stepper motor and/or a positioning actuator for simulating the feedback force (i.e. resistance) experienced by an operator during surgery, including gravity force of the surgical instrument 201, and the resistance encountered during the simulated surgery. The position of the actuator 102 may be detected and recorded by an internal or external three-dimensional sensor. The surgical instrument 201 can be detachably connected to the surgical instrument connection component 103. The surgical instrument 201 can be a piercing and/or incision instrument, or a surgical instrument for performing other surgical operations. For example, the surgical instrument 201 may include a rotatable handle and a needle, blade, stoma dilator, stoma sheath, penetration-type probe or lens provided on the handle.

The three-dimensional tracker 403 can be a sensing device such as a depth camera, an optical tracker, or an electromagnetic tracker for tracking the location and orientation of the exposed portion of the surgical instrument 201, detecting and recording the position of an incision point and/or piercing point 303 on the physical model 301 by the surgical instrument 201. The three-dimensional tracker 403 can track the movement of the surgical instrument 201 and transmit the acquired information to the control module. In the present application, the control module, via a visional analysis algorithm, may employ a template-matching method to identify the portion of the surgical instrument 201, e.g. needle or blade of the surgical instrument 201, which is pierced into the physical model 301. This can be used to accurately calculate the deformation and haptic simulation of the virtual organ and the surgical instrument, thereby enhancing the accuracy of the calculation and estimate the degree of bending of the inserted surgical instrument.

The display device 401 can be a general display device, or a display device with a touch screen for displaying the surgical instrument, a virtual organ, and/or a medical image 402.

The control module can be a computer or a server for controlling the entire surgery simulation system. The control module may have electrical signal connection with the force feedback device 101, the three-dimensional tracker 403 and the display device 401 respectively. The control module can control the force feedback device 101 according to the signals of the actuator 102 and the three-dimensional tracker 403, and display a corresponding image on the display device 401. The magnitude of the feedback force of the force feedback device 101 may be calculated by the control module based on the signal of the three-dimensional tracker 403.

Force model calculation for the piercing and/or incision operation takes into account the path-restraining force received by the simulation platform as well as force model at other various stages.

Before the surgical instrument 201 is inserted into the physical model 301, feedback force, i.e. the gravity force of the simulated surgical instrument 201 may be provided by the force feedback device 101. When the surgical instrument 201 is pierced into the physical model 301, extended calculation of the position of the incision point and/or piercing point 303 can be performed via the surgical instrument connection component 103 and the actuator 102. Feedback force can be provided together by the surgical instrument connection component 103, the force feedback device 101 which is connected with the surgical instrument connection component 103, and the physical model 301. When the surgical instrument 201 is operating in the physical model 301, feedback force can be provided together by the surgical instrument connection component 103, the force feedback device 101 which is connected with the surgical instrument connection component 103, and the friction at the interior of the physical model 301.

The surgical instrument 201 of the surgical simulation system of the present application can be a piercing instrument, an incision instrument, or other surgery instrument. The piercing instrument may include a rotatable handle and a needle provided on the handle. The incision instrument may include a rotatable handle and a blade provided on the handle.

To better simulate the human organ, the physical model 301 may be made of a membrane having a soft surface for repeat incision and/or piercing by the surgical instrument 201. An interior of the physical model 301 may be filled with a soft material that can generate friction when the surgical instrument 201 is inserted therein, and restrains the path of the surgical instrument after insertion.

The control module of the surgery simulation system of the present application may also be provided with an evaluation module to evaluate the performance of the operator. This may assist the operator in reviewing his/her performance and training.

The present application also provides a method for simulating a surgery, the method including:
providing a simulation platform 302, the simulation platform being provided thereon with a physical model 301 that simulates a human organ to be incised and/or pierced;
using a force feedback devices 101 to simulate feedback force acting on an operator during surgery, the force feedback device 101 being connected with an actuator 102 and a surgical instrument connection component 103, position of the actuator 102 being detected and recorded by an internal or external three-dimensional sensor, a surgical instrument 201 being detachably connected with the surgical instrument connection component 103;
using a three-dimensional tracker 403 to track the location and orientation of an exposed portion of the surgical instrument 201, detect and record location of an incision point and/or piercing point on the physical model 301 formed by the surgical instrument 201;
using a display device 401 to display the surgical instrument, a virtual organ and/or a medical image 402; and
using a control module to control the force feedback device 101 according to signals of the actuator 102 and the three-dimensional tracker 403, and displaying a corresponding image on the display device 401.

In the surgery simulation method, before the surgical instrument 201 is inserted into the physical model 301, feedback force can be provided by the force feedback device 101. When the surgical instrument 201 is pierced into the physical model 301, feedback force can be provided together by the force feedback device 101 and the physical model 301. When the surgical instrument 201 is operating in the physical model 301, feedback force can be provided together by the force feedback device 101, and the friction at the interior of the physical model 301.

When performing surgery training using the surgery simulation system and method of the present application, the control module can detect a change based on the signal of the three-dimensional tracker 403 whenever the position of the surgical instrument 201 changes, and synchronize the position and posture of the virtual and real surgical instrument 201. When piercing of the surgical instrument 201 into the physical model 301 on the simulation platform 302 is tracked, the control module will compute the deformation and haptic simulation of the virtual organ and the surgical instrument. The piercing point 303 may also be used to estimate and simulate the degree of bending of the surgical instrument. Simultaneously, the simulation platform can provide additional restraining force for force feedback after piercing. This can greatly enhance the haptic experience. The visual effect of the surgery simulation can be displayed by the display device 401. The evaluation module of the control module of the surgery simulation system can provide an analysis of the accuracy and time management of the surgery simulation operation afterwards so as to help the operator to improve.

The surgery simulation method of the present application can arbitrarily select different positions of a virtual patient's body as through-holes for an ostomy path, and can repeatedly practice ostomy at different through-holes in the same body part (e.g. chest, abdomen, head/neck and limbs).

Embodiments of the surgery simulation system and method have been described above with reference to the accompanying drawings, but they are not limited to the specific embodiments described above. The specific embodiments described above are merely illustrative and not limiting. It will be apparent to those skilled in the art that various changes in form and details may be made therein without departing from the scope of protection as defined by the appended claims.

What is claimed is:

1. A surgery simulation system comprising:
a simulation platform, the simulation platform being provided thereon with a physical model that simulates a human organ to be incised and/or pierced, and allows a surgical instrument to physically incise and/or pierce therethrough;
one or more sets of force feedback devices, each set of the force feedback devices being connected with an actuator and a surgical instrument connection component, position of the actuator being detected and recorded by an internal or external three-dimensional sensor, the surgical instrument being detachably connected with the surgical instrument connection component;
a three-dimensional tracker, being a depth camera, an optical tracker, or an electromagnetic tracker, that tracks location and orientation of an exposed portion of the surgical instrument, detects and records a position of an incision point and/or piercing point on the physical model by the surgical instrument; and
a control module, the control module having electrical signal connection with the force feedback devices, the three-dimensional tracker and a display device, controlling the force feedback devices according to signals of the actuator and the three-dimensional tracker, and displaying a corresponding image on the display device.

2. The surgery simulation system as claimed in claim 1, wherein
before the surgical instrument is inserted into the physical model, feedback force is provided by the force feedback devices;
when the surgical instrument is pierced into the physical model, extended calculation of the position of the incision point and/or piercing point is performed via the surgical instrument connection component and the actuator, and feedback force is provided together by the surgical instrument connection component, the force feedback devices which are connected with the surgical instrument connection component, and the physical model; and
when the surgical instrument is operating in the physical model, feedback force is provided together by the surgical instrument connection component, the force feedback devices which are connected with the surgical instrument connection component, and friction at an interior of the physical model.

3. The surgery simulation system as claimed in claim 1, wherein the surgical instrument is a piercing and/or incision instrument, the surgical instrument comprising a rotatable handle and a needle, blade, stoma dilator, stoma sheath, penetration-type probe or lens provided on the handle.

4. The surgery simulation system as claimed in claim 1, wherein the display device displays the surgical instrument, a virtual organ and/or a medical image.

5. The surgery simulation system as claimed in claim 1, wherein the physical model is formed with a membrane having a soft surface for repeat incision and/or piercing by the surgical instrument, an interior of the physical model is filled with a soft material that generates friction when the surgical instrument is inserted therein, and restricts the surgical instrument's path after insertion.

6. A method for simulating a surgery comprising:
providing a simulation platform, the simulation platform being provided thereon with a physical model that simulates a human organ to be incised and/or pierced;
using a force feedback device to simulate feedback force acting on an operator during surgery, the force feedback device being connected with an actuator and one or more surgical instrument connection components, position of the actuator being detected and recorded by an internal or external three-dimensional sensor, a surgical instrument being detachably connected with the surgical instrument connection components;
using a three-dimensional tracker to track location and orientation of an exposed portion of the surgical instrument, detect and record location of an incision point and/or piercing point on the physical model formed by the surgical instrument, the three-dimensional tracker being a depth camera, an optical tracker, or an electromagnetic tracker; and
using a control module to control the force feedback device according to signals of the actuator and the three-dimensional tracker, and displaying a corresponding image through a display device.

7. The method for simulating a surgery as claimed in claim 6, wherein
before the surgical instrument is inserted into the physical model, feedback force that simulates gravity force of the surgery instrument is provided by the force feedback device;
when the surgical instrument is pierced into the physical model, feedback force that simulate piercing force of the surgery instrument is provided together by the force feedback device and the physical model; and
when the surgical instrument is operating in the physical model, feedback force is provided together by the force feedback device, and friction at an interior of the physical model.

8. The method for simulating a surgery as claimed in claim 6, wherein the surgical instrument is a piercing and/or incision instrument, the surgical instrument comprising a rotatable handle and a needle, blade, stoma dilator, stoma sheath, penetration-type probe or lens provided on the handle, and after the surgery instrument is replaced, the display device accordingly displays the surgery instrument after replacement.

9. The method for simulating a surgery as claimed in claim 6, wherein the display device displays the surgical instrument, a virtual organ and/or a medical image.

10. The method for simulating a surgery as claimed in claim 6, wherein the physical model is formed with a membrane having a soft surface for repeat incision and/or piercing by the surgical instrument, an interior of the physical model is filled with a soft material that generates friction when the surgical instrument is inserted therein, and restricts the surgical instrument's path after insertion.
